(19) United States
(12) Patent Application Publication
(10) Pub. No.: US 2008/0262864 A1
(43) Pub. Date: Oct. 23, 2008

(54) MOBILE EVENT MANAGEMENT SYSTEM

(76) Inventors: Dave Hilmer, St. Peters, MO (US); Dwayne Waser, Imperial, MO (US); Josh Dunbar, St. Charles, MO (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 12/054,000

(22) Filed: Mar. 24, 2008

Related U.S. Application Data
(60) Provisional application No. 60/912,951, filed on Apr. 20, 2007.

(51) Int. Cl. G06Q 10/00

(52) U.S. Cl. 705/1

(57) ABSTRACT

A mobile event management system comprises a portable case openable to form a command workstation at an event having an event zone. The system includes at least one mobile tracking device housed within the portable case during transport and storage of the case and removable from the case during use of the mobile tracking device at the event. The command workstation includes badging equipment to create credentials badges for event personnel and a computer system. Additionally, the mobile tracking device is operable to wirelessly communicate with the computer system. The system further includes event management software loaded on the command workstation and the mobile tracking device. The event management software is preprogrammed to maintain a database of information input into the command workstation and the mobile tracking device to facilitate tracking of objects and people associated with the event with respect to the event zone.

### CROSS-REFERENCE TO RELATED APPLICATIONS

This application is based on provisional patent application Ser. No. 60/912,951, filed Apr. 20, 2007, and priority and the benefit of Ser. No. 60/912,951 is claimed in the present application to the extent the subject matter of this application is found in that provisional application.

### TECHNICAL FIELD

The present disclosure generally relates to a mobile event management system which provides hardware and software for management of events.

### BACKGROUND

Large events with the presence of multiple people and objects are better organized when a system exists to inventory and track personnel and materials involved in the event. Examples of such events can include natural or manmade disaster events which require first responders such as police, medical, fire or military personnel. Examples of such events can also include planned events such as school events or sporting events, or management of construction sites or similar locales. Certain embodiments of the present system provide enhanced ability and flexibility to manage and organize personnel and materials at event locations.

### BRIEF DESCRIPTION OF THE DRAWINGS

FIG. 1 is a perspective view of a mobile event management system according to one embodiment.

FIG. 2 is a perspective view of a mobile tracking device and cradle according to one embodiment.

FIG. 3 is another perspective view of a portion of the mobile event management system illustrated in FIG. 1.

FIG. 4 is another perspective view of a portion of the mobile event management system illustrated in FIG. 1.

FIGS. 5A-7B illustrate optional uses of the system according to certain embodiments.

### SUMMARY

In one embodiment, a mobile event management system comprises a portable case openable to form a command workstation at an event having an event zone. The system includes at least one mobile tracking device housed within the portable case during transport and storage of the case and removable from the case during use of the mobile tracking device at the event. The command workstation includes badging equipment to create credentials badges for event personnel, as well as a computer system. The mobile tracking device is operable to wirelessly communicate with the computer system. Additionally, the system includes event management software loaded on the command workstation and the mobile tracking device. The event management software is preprogrammed to maintain a database of information input into the command workstation and the mobile tracking device to facilitate tracking of objects and people associated with the event with respect to the event zone.

In another embodiment, a mobile event management system comprises a portable case housing a computer system, a printer, and at least one mobile tracking device operable to communicate with the computer system to transmit information input into the mobile tracking device to the computer system. The system includes means for maintaining a database of information input into the computer system and the mobile tracking device, the information relating to people and objects associated with an event. The system further includes means for tracking the people and objects associated with the event, including entry into and exit from an event zone, and means for issuing credentials badges to the people associated with the event.

In yet another embodiment, a method comprises setting up a portable command workstation housed within a portable case at an event having an event zone. Setting up the workstation includes opening the portable case to a portable desk arrangement. The command workstation includes a computer system having event management software, a scanner, a printer, and a mobile tracking device. The method further includes inputting information associated with an event participant into a database of information in the event management software. The inputting information can include scanning an identification card of the event participant. Additionally, the method includes creating a credentials badge containing information associated with the event participant, and printing the credentials badge with the printer for the event participant to carry throughout the event zone to facilitate tracking of the event participant.

### DESCRIPTION OF THE ILLUSTRATED EMBODIMENTS

For the purposes of promoting an understanding of the principles of the invention, reference will now be made to the embodiments illustrated and specific language will be used to describe the same. It will nevertheless be understood that no limitation of the scope of the invention is thereby intended, such alterations, modifications, and further applications of the principles of the invention being contemplated as would normally occur to one skilled in the art to which the invention relates.

Certain embodiments of the mobile event management system allow for onsite object and personnel tracking at emergency or planned events to assist in organization and management of the events. In use, the system can assist management personnel to check an individual's presented credentials on arrival and then issue onsite credentials badges. The system can further provide inventory data relating to personnel and tracking of the movement of personnel in and out of the event zone, as well as inventory data of objects and tracking movement of objects to and from the event. The system optionally provides an onsite network for communication between various people and components and can optionally communicate with a larger area network.

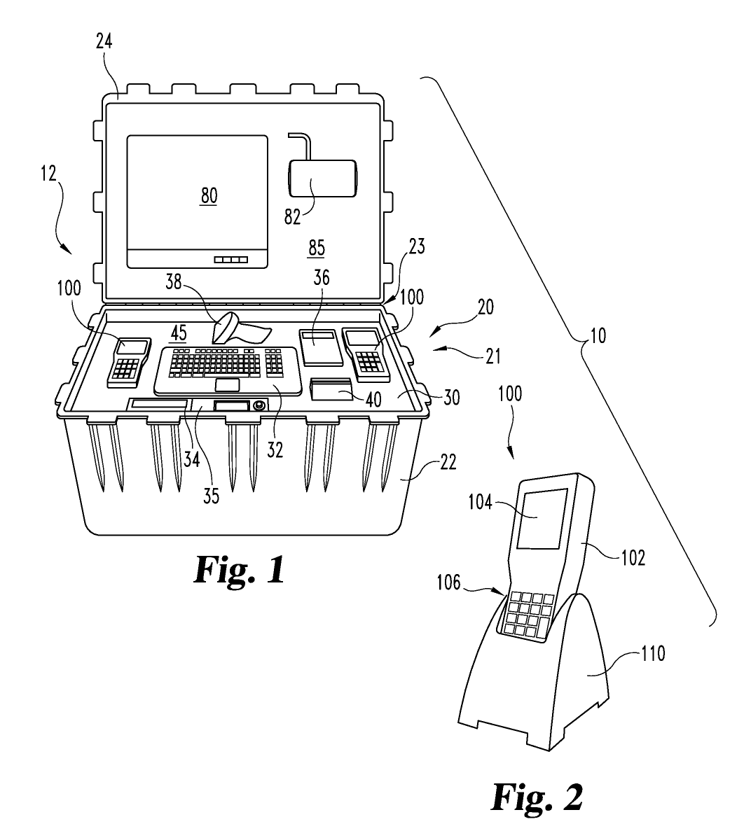

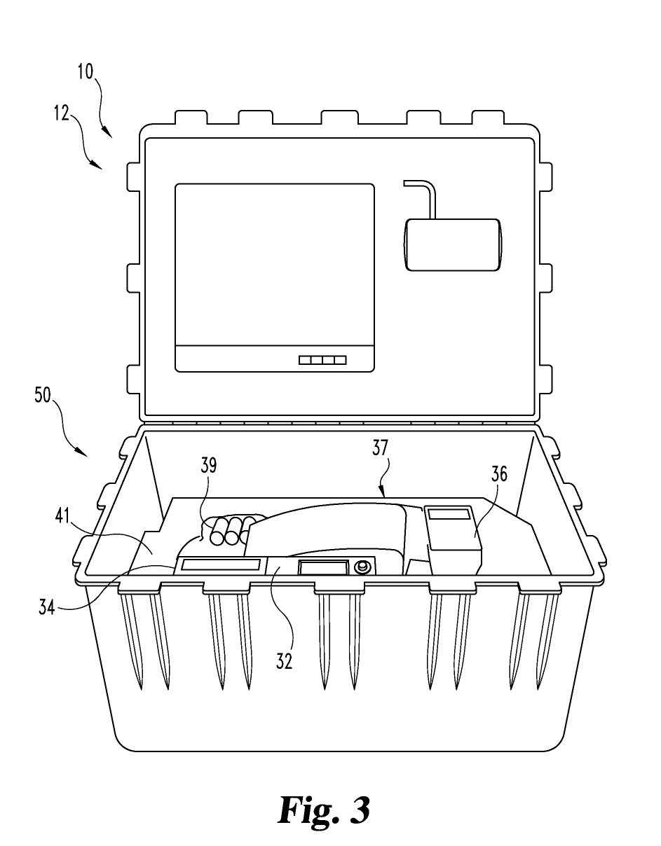

An example embodiment of a mobile event management system 10 is shown in FIGS. 1-4. System 10 is preferably a self-contained portable kit which can be easily transported to an event site and then quickly set up and placed into use. To assist in portability, the system is embodied as portable case 12 openable to create a command workstation 20. Case 12 includes a lower or base portion 22 and an upper portion or lid 24, connected together via hinge assembly 23. In certain embodiments, case 12 is rugged, durable and water resistant. Appropriate wheels and fixed or collapsible handles may be mounted to portable case 12 to assist in transport.

Portable case 12 is openable to form a portable desk type of arrangement housing command workstation 20. Command workstation 20 includes a computer system 21 having typical components such as keyboard and mouse 32, monitor 80, hard drive 52, processor 54 and memory 56. Additionally, computer system 21 is equipped with a power supply 58. The power supply can include a battery or may be plugged into an external power source. Computer system 21 may include optional data communication accessories, such as a CD/RW or DVD/RW drive 34, a wireless transmitter/receiver such as wireless router 82, and other necessary or desired input/output devices or data ports.

Command workstation 20 may further include a badging system housed within case 12 including a badge/card printer 36, a card or magnetic strip reader 40, and various other materials such as card stock to make credentials badges. The badging system may also optionally include photography materials to create a picture for the badges, such as a camera, tri-pod and back drop. Additionally, system 10 has a mobile tracking system including at least one mobile tracking device (“MTD”) 100. In certain embodiments, system 10 includes a bar scanner 38 housed within case 12 for reading information on bar codes or other labels. System 10 may also include various items such as paper, writing utensils, scissors, rubber bands, paper clips, glue and/or other items typically found in a work area.

In certain embodiments, lower base portion 22 of case 12 includes a plurality of layers in which the various components of system 10 are arranged for use and/or arranged during storage and transport. An upper layer 30 is generally used as an operative and accessible layer during use of system 10. In such embodiments, layer 30 can be a work surface for a user of system 10. Upper layer 30 is generally formed with a base 45, for example made of shock absorbing foam. In certain embodiments, base 45 of upper layer 30 includes fasteners or nested locations in which individual components are located and/or secured. In the illustrated embodiment, upper layer 30 includes keyboard and mouse 32, CD or DVD drive 34, radio 35, card printer 36, bar scanner 38, and card reader 40. Additionally, MTDs 100 can be stored on upper layer 30 during transport and storage. Workstation 20 may also include one or more ports for connection of data cables, power cables and accessories, optionally accessible from layer 30. The illustrated components include example components placed on upper layer 30 and can be varied by those of skill in the art.

Adjacent to upper layer 30 during use is hinged lid portion 24 openable to a substantially vertical arrangement to form the portable desk. In the illustrated embodiment, lid 24 includes monitor 80 and wireless router 82 mounted to an inside surface thereof. However, it is contemplated that the components and/or accessories mounted to lid 24 may also be varied by those of skill in the art. The components in lid 24 are secured to the lid and preferably protected by shock absorbing foam 85. The hinges or supports of hinge assembly 23 may be freely movable or selectively lockable to hold the lid in an open position.

FIG. 3 illustrates case 12 with upper layer 30 removed, showing a middle or supply layer 50 below the upper layer. In the illustrated embodiment, case 12 includes a single middle layer 50; however, it should be appreciated that in other embodiments there could be a greater number of middle layers, and in yet other embodiments the middle layer could be absent. Middle layer 50 may include an arrangement of useful components and onsite supplies such as the paper or card stock to make identification credentials badges, the photography equipment, and/or various typical desk items such as paper and writing utensils. In the illustrated embodiment, body portion 37 of card printer 36 is arranged on middle layer 50, with the outlet of the printer extending up through a corresponding hole in base 45, such that printer 36 is accessible via upper layer 30. Card printer 36 can include paper rolls 39 used during the operation of the printer. In addition to body portion 37, portions of other accessories requiring less access, such as the body of CD/DVD drive 34 or radio 35, can also extend into or through middle layer 50. The supplies within middle layer 50 are preferably cushioned by foam panel 41 and may be loosely arranged or organized with compartments, dividers or fasteners.

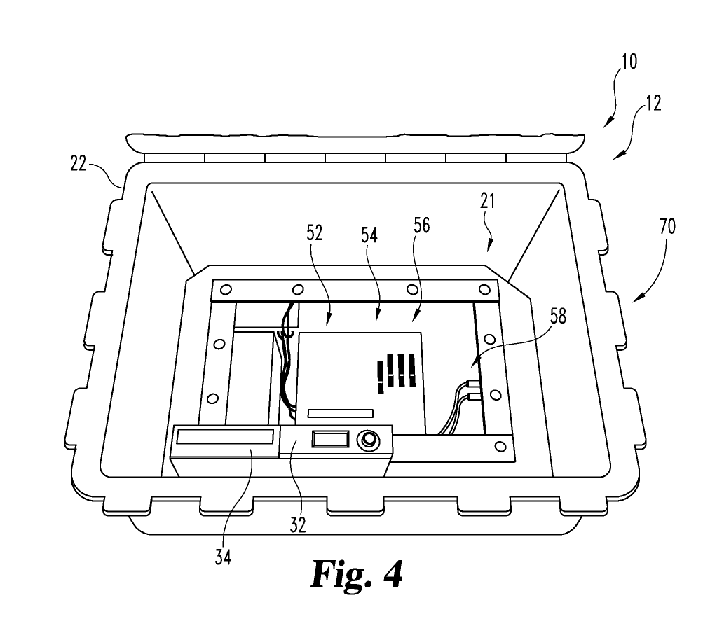

As illustrated in FIG. 4, below middle layer 50 is a technology layer 70 with additional hardware. As examples, technology layer 70 may include components of computer system 21 such as hard drive 52, processor 54, and memory 56, as well as power supply 58. Additional input/output devices such as a CD or DVD drive or data ports may optionally be included in the technology layer. In certain embodiments, technology layer 70 is liquid cooled to maintain a preferred operating temperature for processor 54 and other components.

System 10 may further include one or more communication devices and means, such as wireless network server or terminal software and hardware, radio frequency or infrared (IR) communication capabilities for transmitting and receiving, and ports for direct connection to information sources such as a landline, cellular or satellite telephone network, the Internet, or a local or wide area network. Command workstation 20 may include output communication modes for transmitting data and information to outside systems as a backup or for synchronizing databases. Portable storage devices or peripherals, such as USB drives or devices may also be connectable to workstation 20. In certain embodiments, the components of system 10 communicate with each other using standardized protocols. The communication links may be secured, for example using encryption. The physical components of system 10 are optionally securable as well, for example with case 12 having a durable, water-resistant construction and locking features. A speaker and microphone can optionally be included in system 10 to facilitate voice communications. Additionally, system 10 optionally can include automated sensors for tracking, such as passive or manual detectors at entry and exit points of the event site defining the event zone.

As mentioned above, system 10 includes one or more MTDs 100 which can be stored in case 12 and removable from case 12 to become portable units around the event site. In the illustrated embodiment, MTD 100 includes a case 102 with a screen 104 and an interactive keyboard 106. In certain embodiments, MTD 100 is battery powered. MTD 100 may optionally be charged in a cradle mounted or stored in case 12, or alternately or additionally can be charged in a stand alone cradle 110. MTD 100 typically includes a battery power supply, internal processor and one or more communication modes. Example communication modes include a wireless network using radio frequency (“RF”) or infrared (“IR”) signals, a telephone or radio with microphones, speakers, transmitters and receivers or a direct connection cable which can be connected to communicate or synchronize data with a command station. MTD 100 may optionally include passive or manual detection sensors such as a bar code scanner or an RFID tag reader to collect data.

System 10 includes event management software preloaded on computer system 21 and MTDs 100 to facilitate event management and communication between the components during use of system 10 at an event. In certain embodiments, the event management software maintains a database of information relating to people and objects associated with an event. Examples of personnel information which can be included in the database include identifying information, credentialing information, certificates and specialties related to the individual, as well as check in and check out functions for tracking attendance and current location. Examples of object information which can be included in the database include identifying information such as the type of object, the manufacturer, and the model number, the person who is assuming control over the object, as well as check in and check out functions for tracking the object.

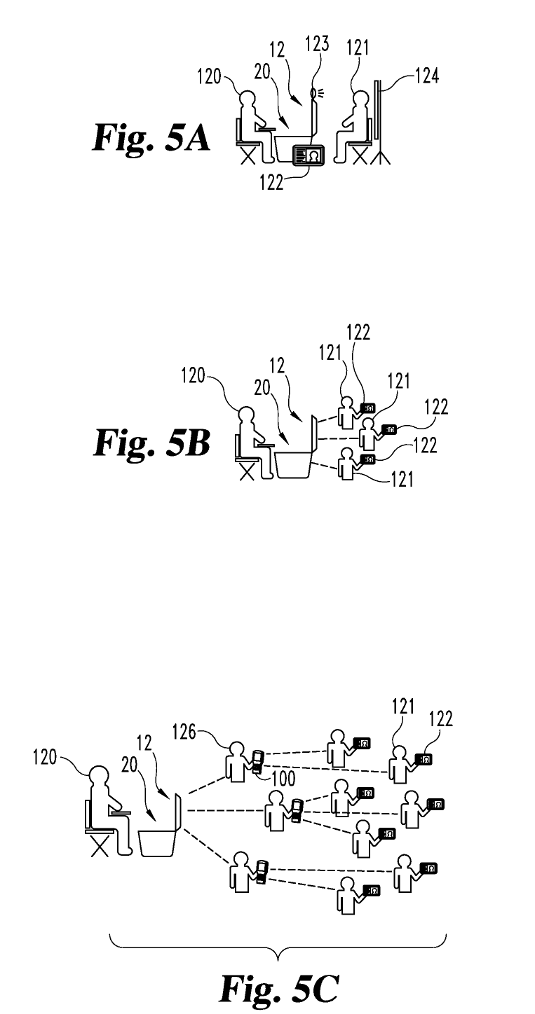

As an example use illustrated in FIG. 5A, command workstation 20 is used as a central location where a user or authority person 120 can receive personnel 121 arriving at the event site such as professional personnel or volunteers. The person arriving can present their pre-existing credentials from which personal information can be input into the event management software database or another appropriate location within computer system 21. Such information can be input into workstation 20 for example using card reader 40, scanner 38 or keyboard 32. Optionally, photographs of the personnel can be taken using camera 123 and backdrop 124. After verification, the personnel can be issued onsite credentials and tracking badges 122, optionally with a photo, using card printer 36 or another appropriate output device. The personnel can then be monitored or tracked via badges 122 and the information within the event management software database (see FIG. 5B).

As illustrated in FIG. 5C, entry and exit of the personnel from the event zone can be monitored or tracked using the event management software with the command workstation 20 and MTDs 100. In such embodiments, a select group of personnel 126 can use MTDs 100 to track personnel 121 by scanning badges 122 to track the person's entry into and exit from the event zone. Badges 122 can be scanned by MTDs 100 or bar code scanner 38 or another appropriate scanner compatible with system 10. In certain embodiments, MTDs 100 are capable of communicating wirelessly with computer system 21 via router 82 to transfer the scanned information to the computer system for input into the event management software database.

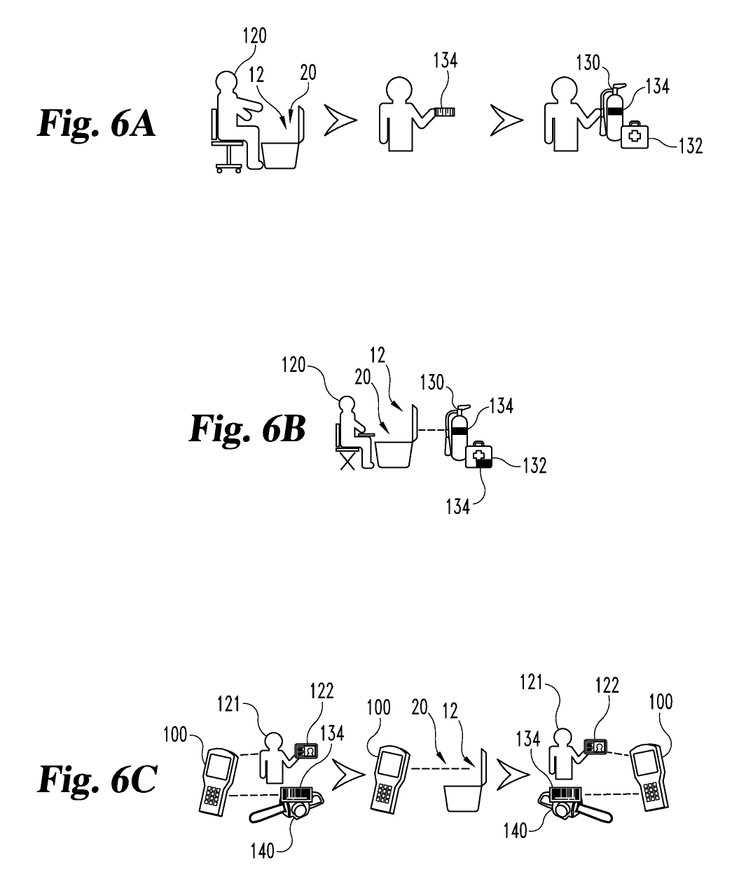

Similar to inventorying and tracking personnel, system 10 allows tracking of assets and material (FIGS. 6A-6C). For example, object identifying information can be input into the event management software database with an input device and then a tracking identifier can be issued. Example tracking identifiers can include a label with a bar code or an RFID tag. A running inventory can be kept and entry and exit of the object can be tracked using the software, command workstation 20 and MTDs 100.

In the example illustrated in FIGS. 6A-6B, the illustrated fire extinguisher 130 and first aid medical kit 132 can be inventoried and tracked using system 10. Authority person 120 can input information relating to the event objects into the event management software database to facilitate tracking of the objects. In certain embodiments, authority person 120 can create and print object labels 134 having bar codes specific to each event object which can be scanned to track the objects.

As illustrated in FIG. 6C, event objects such as chain saw 140 as an example can be checked out by event personnel 121 having credentials badge 122. The event object can be checked out by personnel at a location remote from case 12 via MTD 100. In such cases, MTD 100 can be used to scan badge 122 associated with the particular event personnel 121 and scan the bar code label 134 on the object to associate the object and person together. Thereafter, MTD 100 may be operable to wirelessly transmit the scanned information to workstation 20 at portable case 12. When event personnel no longer require use of the event object, the object can be checked back in using MTD 100. In other embodiments, event objects can be checked out and checked in by authority person 120 at workstation 20.

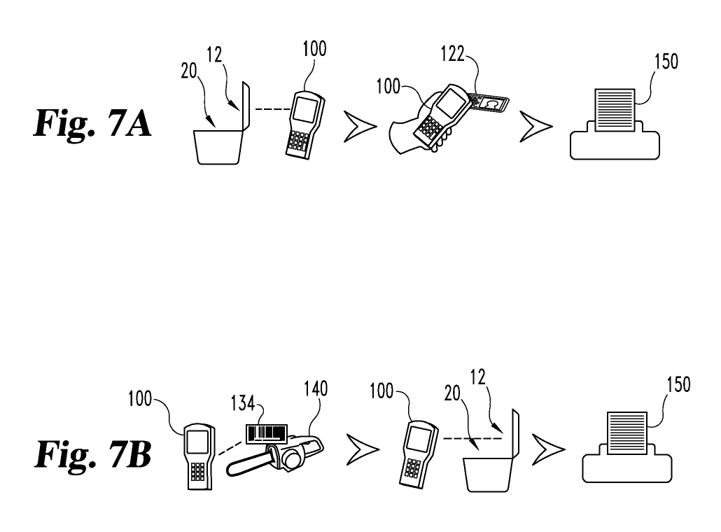

In certain embodiments, command workstation 20 is further operable to help prepare and generate reports relating to information in the event management software database which has been entered and tracked, with accompanying history. Examples of such reports include onsite monitoring for hours reimbursement of event personnel, inventory tracking and general event analysis regarding efficiency and staffing. FIG. 7A illustrates an example method in which MTD 100 is operable to scan a person's credentials badge 122 and transmit the scanned information to the database. Thereafter, a user of system 10 can generate a report providing the identifying and tracking information for the particular event personnel. Additionally, FIG. 7B illustrates another example method in which MTD 100 is operable to scan an object bar code label 134 and transmit the scanned information to the database. Thereafter, a user of system 10 can generate a report providing the general component information and tracking details for the particular event object.

System 10 may be assembled as a self-contained portable kit for easy set-up, breakdown, transport and storage of the system. It certain embodiments, a sub-system may be provided which includes certain of the components of system 10. As an example, a credentialing sub-system version may include a case which is openable to form a command workstation and components operable to make credentials badges. The credentialing sub-system may include a computer system, a printer, and badging system. The badging system may include a card reader, badge-creating materials, and photography equipment such as a camera and optionally a tri-pod and a backdrop. In the credentialing sub-system, the computer system may include badging software preloaded thereon to facilitate creating the credentials badges.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

1. A mobile event management system, comprising:
a portable case openable to form a command workstation at an event having an event zone;
at least one mobile tracking device housed within said portable case during transport and storage of said case and removable from said case during use of said mobile tracking device at the event;
wherein said at least one mobile tracking device is operable to wirelessly communicate with said command workstation; and
event management software loaded on said command workstation and said mobile tracking device, wherein said event management software is preprogrammed to maintain a database of information input into said command workstation and said at least one mobile tracking device to track of objects and people associated with the event with respect to the event zone.

2. The system of claim 1, wherein said command workstation includes badging equipment to create credentials badges for event personnel.

3. The system of claim 2, wherein said badging equipment includes a card reader, badge material, a printer, and a photography system.

4. The system of claim 1, wherein said case includes a plurality of layers in which the components of the system are stored during transport.

5. The system of claim 1, wherein said case includes a hinge member separating a top cover and a base portion such that said case is openable to form a portable desk, wherein said top cover includes an inner surface with a display mounted thereto and said base portion includes a work surface.

6. The system of claim 5, wherein said base portion includes at least two storage layers including a first top layer having at least said work surface and said mobile tracking device while said mobile tracking device is housed within said case.

7. The system of claim 1, wherein said mobile tracking device includes at least one detection sensor to read information.

8. The system of claim 1, wherein the system includes a power supply.

9. The system of claim 1, wherein the system includes detectors for detecting entry into and exit from the event zone of objects and people associated with the event.

10. A mobile event management system, comprising:
a portable case openable to form a workstation having a computer system, a printer, and at least one removable mobile tracking device operable to communicate with said computer system to transmit information input into said mobile tracking device to said computer system;
means for maintaining a database of information input into said computer system and said mobile tracking device, said information relating to people and objects associated with an event; and
means for tracking the people and objects associated with the event, including entry into and exit from an event zone.

11. The system of claim 10, further comprising means for generating reports based on information in said database.

12. The system of claim 10, further comprising means for issuing credentials badges to the people associated with the event.

13. The system of claim 10, further comprising means for creating bar code labels for the objects based on information in said database and means for scanning said bar code labels.

14. The system of claim 13, wherein said mobile tracking device is operable to read said bar code labels remote from said portable case and transmit information to said computer system.

15. A method, comprising:
setting up a portable command workstation housed within a portable case at an event having an event zone, wherein said setting up includes opening said portable case to a portable desk arrangement with a work surface and a display, wherein said command workstation includes a computer system having event management software, a scanner, a printer, and a mobile tracking device;
inputting information associated with an event participant into a database of information in said event management software, wherein said inputting information includes scanning an identification card of the event participant;
creating a credentials badge containing information associated with the event participant; and,
generating said credentials badge for the event participant to carry within the event zone to facilitate identification and tracking of the event participant.

16. The method of claim 15, further comprising tracking the entry into and exit from the event zone of the event participant by scanning said credentials badge.

17. The method of claim 15, further comprising generating a report based on information in said database.

18. The method of claim 15, further comprising scanning said credentials badge with said mobile tracking device at a location remote from said command workstation to receive scanned information specific to the event participant to facilitate tracking of the event participant.

19. The method of claim 18, further comprising wirelessly transmitting the scanned information from said mobile tracking device to said command workstation.

20. The method of claim 15, further comprising:
inputting information associated with an event object into said database;
developing a label containing a bar code for said object based on said information associated with said object;
printing said label with said printer;
attaching said label to said object; and
tracking said object with respect to the event zone, wherein said tracking includes scanning said label to input scanned information associated with said object into said database.
